(19) United States
(12) Patent Application Publication
(10) Pub. No.: US 2005/0262501 A1
(43) Pub. Date: Nov. 24, 2005

(54) Software distribution method and system supporting configuration management

(76) Inventors: Claudio Marinelli, Aprilia (IT); Luigi Pichetti, Roma (IT); Marco Secchi, Roma (IT)

Correspondence Address: IBM CORPORATION;INTELLECTUAL PROPERTY LAW, 11400 BURNET ROAD, AUSTIN, TX, 78758, US

(21) Appl. No.: 11/126,118

(22) Filed: May 10, 2005

(30) Foreign Application Priority Data
May 21, 2004 (EP) 04102244.3

(51) Int. Cl. G06F 9/445

(52) U.S. Cl. 717/174; 717/168

(57) ABSTRACT

A software distribution method (300) and a corresponding system are proposed. In the solution of the invention, each software package (which is used to deploy a desired software product) includes the definition of installation actions and configuration actions; the installation actions are used to load the software product (including its initial configuration), whereas the configuration actions are used to set configuration options of the software product after the installation. The software package can be applied (316-332;346) on each endpoint specifying an installation activity or a configuration activity (involving the execution of the corresponding actions). In this way, it is possible to reconfigure (346) a software product that is already available without its reinstallation; moreover, it is possible to correct (374) configuration errors directly on the endpoint.

### TECHNICAL FIELD

The present invention relates to the data processing field. More specifically, the present invention relates to a software distribution method. The invention further relates to a computer program for performing the method, and to a product embodying the program. Moreover, the invention also relates to a corresponding software distribution system.

### BACKGROUND ART

Distribution of software products is a time consuming activity, particularly in a system including a great number of target computers (or endpoints) on which the software products must be installed. A typical example is that of a large network with hundreds of workstations, wherein software products are periodically upgraded in order to be abreast of the information technology development.

Software distribution applications have been proposed in the last years to assist a system administrator in efficiently managing deployment of software products from a central site of the system. An example of software distribution application is the “Tivoli Configuration Manager” by IBM Corporation. Typically, a software distribution application controls the building of software packages including instructions specifying the actions to be carried out on the endpoints for installing or removing corresponding software products; each software package can further embed an image of the software products to be installed on the endpoints. The software package is transmitted to each endpoint, and the corresponding instructions are interpreted so as to execute the desired actions.

As described in WO-A-003085513 (the entire disclosure of which is herein incorporated by reference), some software distribution applications also provide the possibility of verifying whether the endpoint is still in the state, which has been enforced by the actions executed at the distribution time. This feature allows detecting any inconsistencies in the endpoint (for example, caused by the corruption or the deletion of some files). In this way, it is also possible to restore the desired condition of the software products automatically.

However, the solutions known in the art are not completely satisfactory. Particularly, all the software distribution applications are specifically designed for managing the installation (or the removal) of the software products (including their initial configuration). Conversely, no support is available for managing further configurations of the software products after their installation.

In other words, whenever the configuration of a software product must be changed the solutions described above require the whole software product to be reinstalled.

Likewise, the only way to restore a software product being in an error condition is that of forcing its complete installation (since the values that have been used to configure the software product at the distribution time are not persistent).

The above-mentioned drawbacks are particular acute in high-dynamic environments, wherein the configuration of the software products must be changed frequently.

### SUMMARY OF THE INVENTION

It is an object of the present invention to provide a solution for managing either the installation or the configuration of the software products in software distribution applications.

Particularly, it is an object of the present invention to allow configuring software products without requiring their complete installation.

It is another object of the present invention to support the reconfiguration of software products that are already installed.

It is yet another object of the present invention to allow restoring software products being in an error condition without their whole installation.

The accomplishment of these and other related objects is achieved by a solution, which is based on the possibility of selecting different categories of actions in the software package.

Particularly, an aspect of the present invention provides a software distribution method including the steps of: providing a software package defining a plurality of actions for deploying a software product, the actions being partitioned into an installation category for loading the software product and a configuration category for setting configuration options of the software product, selecting at least one of the categories, and applying the software package on a target data processing entity to execute the actions of the at least one selected category.

Preferably, at least one action of the configuration category defines one or more formal parameters for the setting of a corresponding configuration option; each formal parameter is then resolved into a desired value of the configuration option.

A way to improve the solution is to include a mapping structure (associating one or more formal parameters with their desired values) into the software package.

As a further enhancement, the formal parameters are resolved on the target data processing entity.

An embodiment of the present invention involves performing a first application of the software package (with the selection of the installation category and the configuration category) and then a second application of the same software package (with the selection of the configuration category only).

In a further embodiment, the method verifies a compliance of the target data processing entity with each executed action; each action of the configuration category and the installation category is then re-applied in response to a negative result of the verification (in order to restore the loading of the software product and the setting of the configuration options, respectively).

Preferably, an indication of the setting of the configuration options is stored on the target data processing entity.

Further aspects of the present invention provide a computer program for performing the method and a product embodying the program.

Moreover, a still further aspect of the invention provides a corresponding software distribution system.

The solution of the present invention adds flexibility to the software distribution applications. Particularly, the proposed method can be used for managing either the installation or the configuration of the software products.

The devised solution allows configuring the software products without requiring their reinstallation.

For example, it is possible to reconfigure software products that are already installed in a very simple way.

Moreover, the solution of the invention makes it possible to restore software products being in an error condition without forcing their complete installation.

The above-mentioned advantages are clearly apparent in high-dynamic environments (wherein the configuration of the software products must be changed frequently), even if other applications are not excluded.

The novel features believed to be characteristic of this invention are set forth in the appended claims. The invention itself, however, as well as these and other related objects and advantages thereof, will be best understood by reference to the following detailed description to be read in conjunction with the accompanying drawings.

### BRIEF DESCRIPTION OF THE DRAWINGS

FIG. 1a is a schematic block diagram of a data processing system in which the method of the invention is applicable;

FIG. 1b shows the functional blocks of a generic computer of the system;

FIG. 2 depicts the main software components that can be used for practicing the method;

FIGS. 3a-3d show a diagram describing the flow of activities relating to an illustrative implementation of the method.

### DETAILED DESCRIPTION OF THE PREFERRED EMBODIMENT(S)

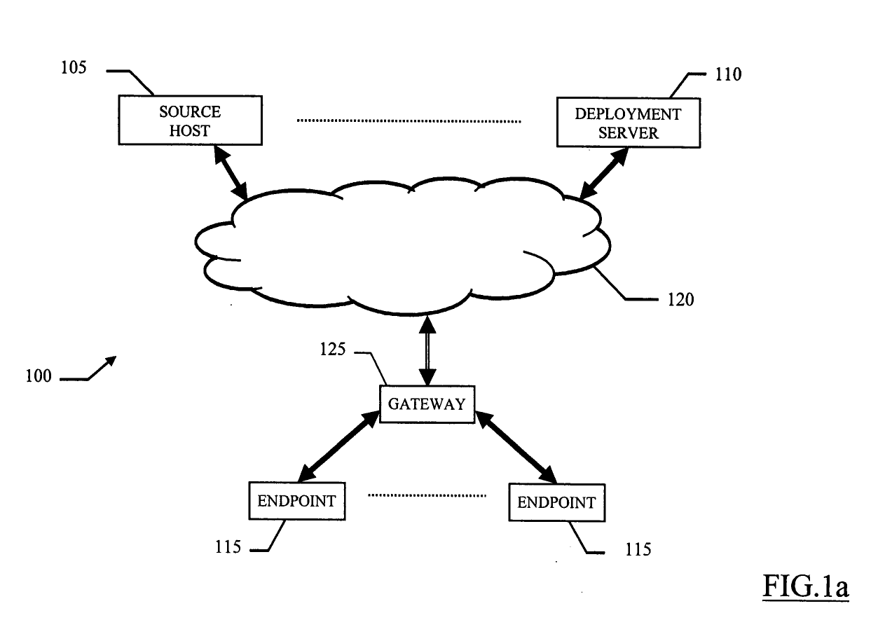

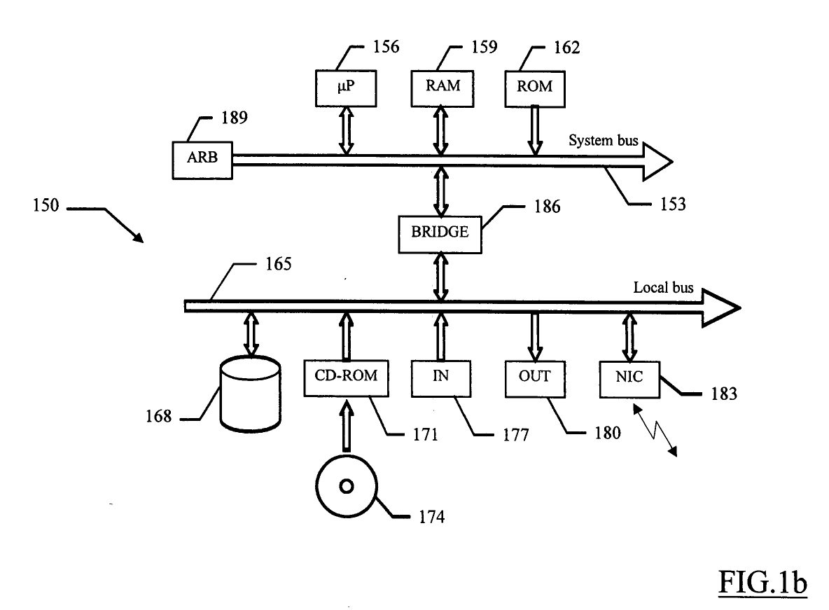

With reference in particular to FIG. 1a, a data processing system 100 with distributed architecture is illustrated. A source host 105 operates as a preparation and testing central site for software products to be distributed throughout the system 100. The source host 105 interfaces with a deployment server 110, which controls the distribution of the software products to multiple endpoints 115. For this purpose, the source host 105, the deployment server 110 and the endpoints 115 are coupled through a network 120, typically INTERNET-based. The source host 105 and the deployment server 110 access the network 120 directly; conversely, the endpoints 115 are clustered around one or more levels of gateways 125.

As shown in FIG. 1b, a generic computer of the system (source host, deployment server, endpoint or gateway) is denoted with 150. The computer 150 is formed by several units that are connected in parallel to a system bus 153. In detail, one or more microprocessors (μP) 156 control operation of the computer 150; a RAM 159 is directly used as a working memory by the microprocessors 156, and a ROM 162 stores basic code for a bootstrap of the computer 150. Peripheral units are clustered around a local bus 165 (by means of respective interfaces). Particularly, a mass memory consists of a hard-disk 168 and a drive 171 for reading CD-ROMs 174. Moreover, the computer 150 includes input devices 177 (for example, a keyboard and a mouse), and output devices 180 (for example, a monitor and a printer). A Network Interface Card (NIC) 183 is used to connect the computer 150 to the network. A bridge unit 186 interfaces the system bus 153 with the local bus 165. Each microprocessor 156 and the bridge unit 186 can operate as master agents requesting an access to the system bus 153 for transmitting information. An arbiter 189 manages the granting of the access with mutual exclusion to the system bus 153.

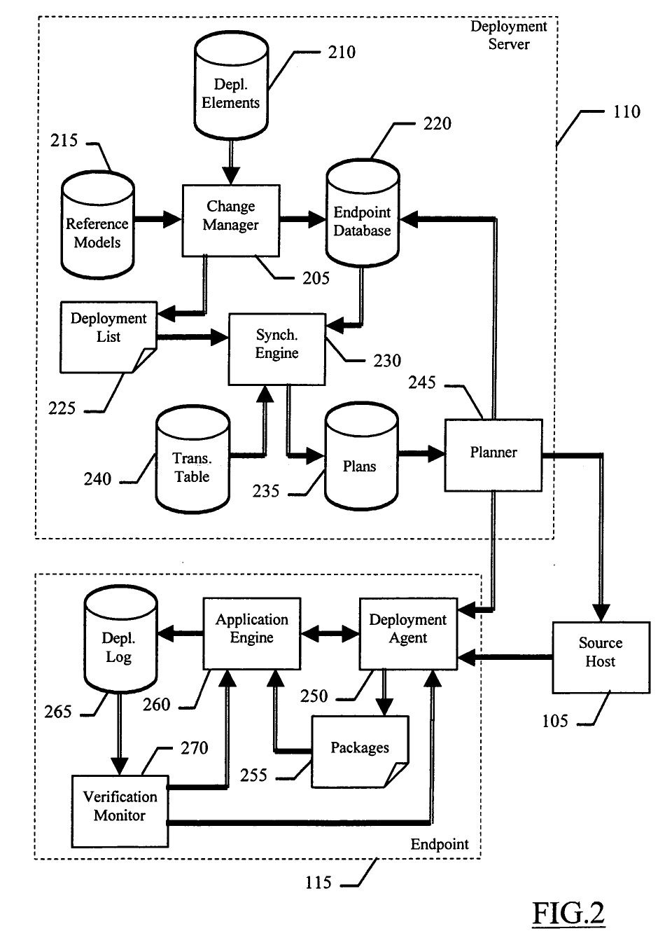

Considering now FIG. 2, the main software components that can be used to practice the method of the invention are illustrated. The information (programs and data) is typically stored on the hard-disks and loaded (at least partially) into the corresponding working memories when the programs are running. The programs are initially installed onto the hard-disks from CD-ROMs.

With reference in particular to the deployment server 110, a change manager 205 controls a repository 210 of deployment elements. Each deployment element defines an entity to be used during a software distribution process; typically, the deployment element provides a reference to a software package that is available on the source host 105.

A preferred structure of the software package is described in the above-mentioned document WO-A-003085513. Briefly, the software package is logically organized into a hierarchical structure starting from a root node. Each leaf node of the hierarchical structure corresponds to an action to be performed on the endpoints during the distribution process; some actions are self-contained (for example, to reboot the endpoint), whereas other actions take a subject referred to as an installable object (for example, consisting of a software resource to be added, replaced or removed). Each node of the hierarchical structure causes a class to be instantiated. The class exposes a series of attributes, which enable the execution of the corresponding action when evaluated to true. For example, the action is conditioned to different hardware parameters of the endpoint (such as the CPU model or the RAM size), to the operating system installed thereon, and the like. The class further exposes a method for verifying whether the action can be performed or reversed on the endpoint, and a method for causing its actual execution. The class for an action with an installable object also exposes a series of attributes for the purpose of resource version control. Said class has an associated class for the respective installable object; the associated class exposes an attribute specifying whether the corresponding resource may be shared among multiple software packages.

The software package is defined by an instruction section (also called software package file), which is generated by serializing the hierarchical structure into a binary representation. For this purpose, the hierarchical structure is traversed top-down and a coding method is called on each class for adding a corresponding record to the instruction section. Alternatively, the software package is described with a plain text file, which is based on a sequence of stanzas (each one representing an action); in this case, the instruction section is generated interpreting the text file with conventional parsing techniques.

The software package is built from its instruction section. For this purpose, the name assigned to each record is used to access a lookup table specifying the corresponding class; once the class has been instantiated, a decoding method is called on the class for generating the corresponding hierarchical structure. The hierarchical structure is then traversed, and a building method is called on each class; if the class has an associated installable object, this method retrieves and adds an image of the required resource to the software package.

In a preferred embodiment of the invention, the actions are partitioned into two distinct categories: an installation category and a configuration category. The installation actions are used for loading/unloading the software product (i.e., adding, replacing or removing corresponding resources with their initial configuration); conversely, the configuration actions are used for setting the software product (i.e., modifying operative options of resources that are already installed). The different categories are discriminated by means of an attribute, which is exposed by the class corresponding to each action. For example, the installation actions cause the creation of a folder, the copy or the deletion of a file, whereas the configuration actions involve the modification of port numbers, and the like. The configuration actions can include one or more formal parameters (to be resolved at run-time) for the setting of the operative options.

The change manager 205 further controls a repository 215 of reference models. Each reference model specifies an installation desired state of one or more selected software packages on the endpoints subscribing to the reference model; for example, the installation desired state indicates that the software product must be installed in an undoable manner, committed, or removed. At the same time, the reference model also specifies a corresponding configuration desired state of those software packages; preferably, the configuration desired state is defined by means of a mapping list, which consists of a series of key/value pairs each one providing a desired value of a corresponding formal parameter (included in the configuration actions). For example, the mapping list indicates the number of a listening port, the name of a remote host, and the like.

The subscribers are identified by a role, which specifies a functional group of endpoints; for example, the role is defined by the computers assigned to a category of users (such as developers, secretaries, managers), belonging to a selected department, or having specific features. The endpoints of a generic role can be characterized either statically (for example, by means of a list) or dynamically (for example, by means of a query).

A database 220 stores information about each endpoint 115 of the system. The endpoint database 220 specifies the (installation and configuration) actual state of the software packages that have been distributed to the endpoint 115. Particularly, the endpoint database 220 indicates whether each software package has been correctly applied (so as to reach its installation desired state); at the same time, the endpoint database 220 stores the values that have been used to configure the corresponding software product.

The software distribution process involves the dynamic generation of a deployment list 225 by the change manager 205; for each endpoint belonging to the role indicated in a selected reference model, the deployment list 225 specifies the installation and configuration desired state of the software packages specified in that reference model.

The deployment list 225 is supplied to a synchronization engine 230, which also accesses the endpoint database 220. The synchronization engine 230 generates a plan 235, which specifies the activities to be performed on each endpoint (associated with the selected reference model) for reaching the installation and configuration desired state of each relevant software package. For this purpose, the synchronization engine 230 exploits a transition table 240, which indicates the activities required to reach each installation desired state from each current state. In detail, the plan 235 indicates that each software package must be installed on the endpoints where it is not available yet; moreover, the plan indicates that each software package must be configured (according to the associated mapping list) on the endpoints where it is already installed but not configured correctly.

The activity plan 235 is submitted to a planner 245, which controls execution of the desired activities on the endpoints. Particularly, the planner 245 instructs the source host 105 to build and distribute the required software packages to the endpoints 115. Moreover, the planner 245 updates the information relating to each endpoint 115 in the database 220, according to the result of the application of the software packages.

Moving now to a generic endpoint 115, a deployment agent 250 (running in the background) controls communication with the deployment server 110 and the source host 105 (through the associated gateways, not shown in the figure). The deployment agent 250 downloads the required software packages (denoted with 255) from the source host 105. The deployment agent 250 interfaces with an engine 260, which enforces the application of the software packages 255 on the endpoint 115.

The application engine 260 stores an indication of the installation and configuration actions that have been executed on the endpoint 115 into a deployment log 265 (together with the values that have been used for the configuration options); preferably, the deployment log 265 also includes a back-up copy of any resources that have been updated or removed as a result of the execution of the installation actions.

A verification module 270 accesses the deployment log 265. The module 270 verifies whether the endpoint 115 is still compliant with the actions stored in the deployment log 265 (i.e., whether the corresponding resources are in the condition that have been enforced by the execution of the actions). For example, the verification module 270 checks that a resource that has been added is actually present, that a configuration option is set to the correct value, and the like. The verification module 270 interfaces with the deployment agent 250 and with the application engine 260 for restoring the correct condition of the non-compliant resources of the endpoint 115.

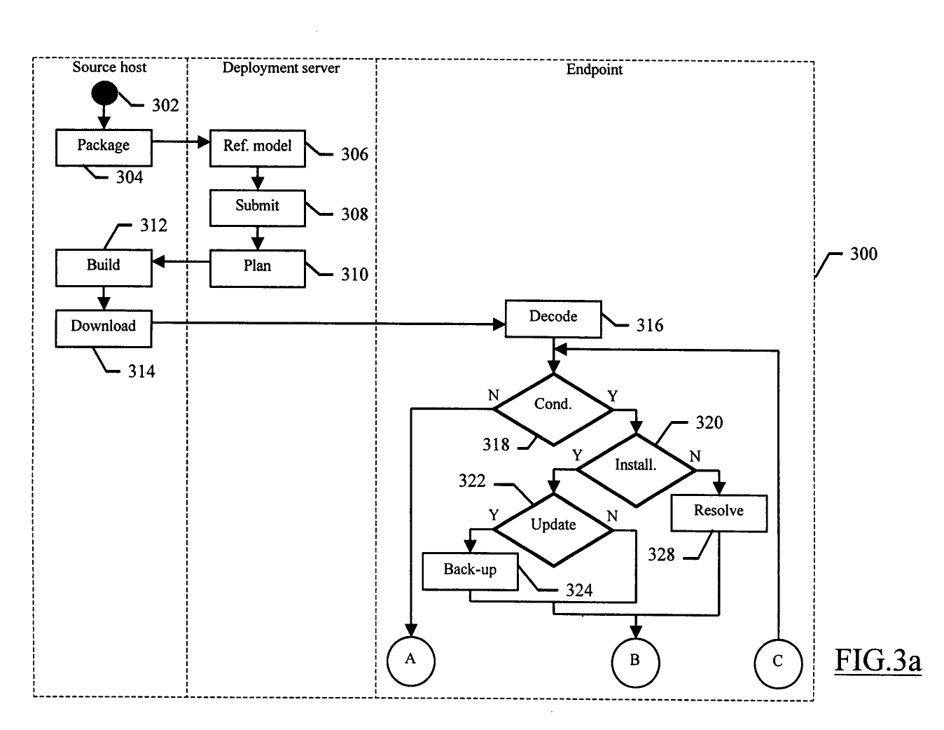

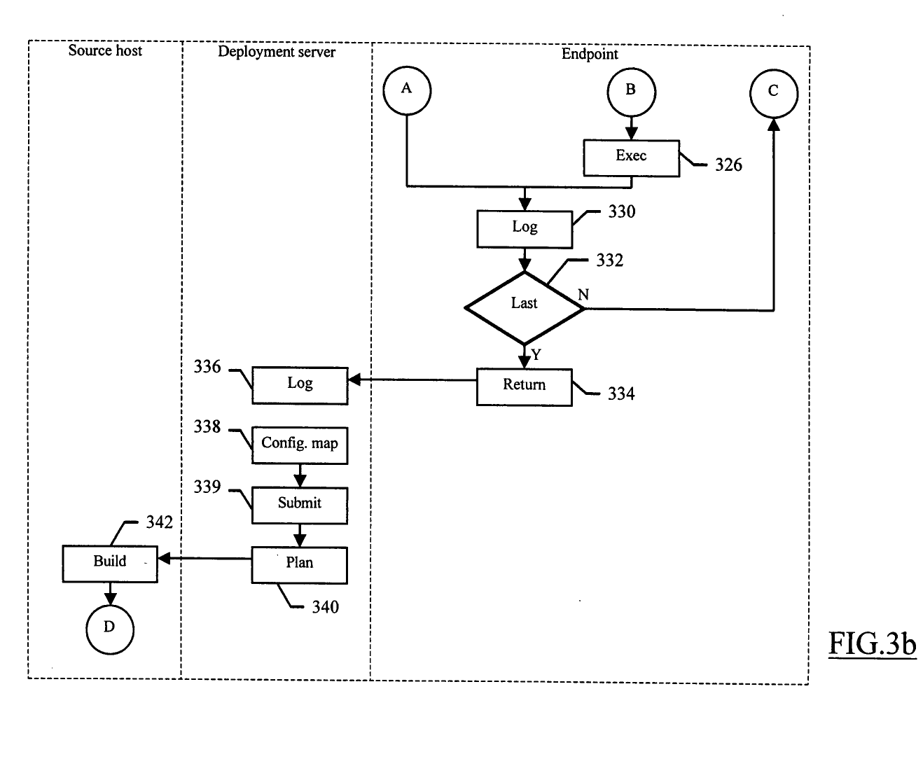

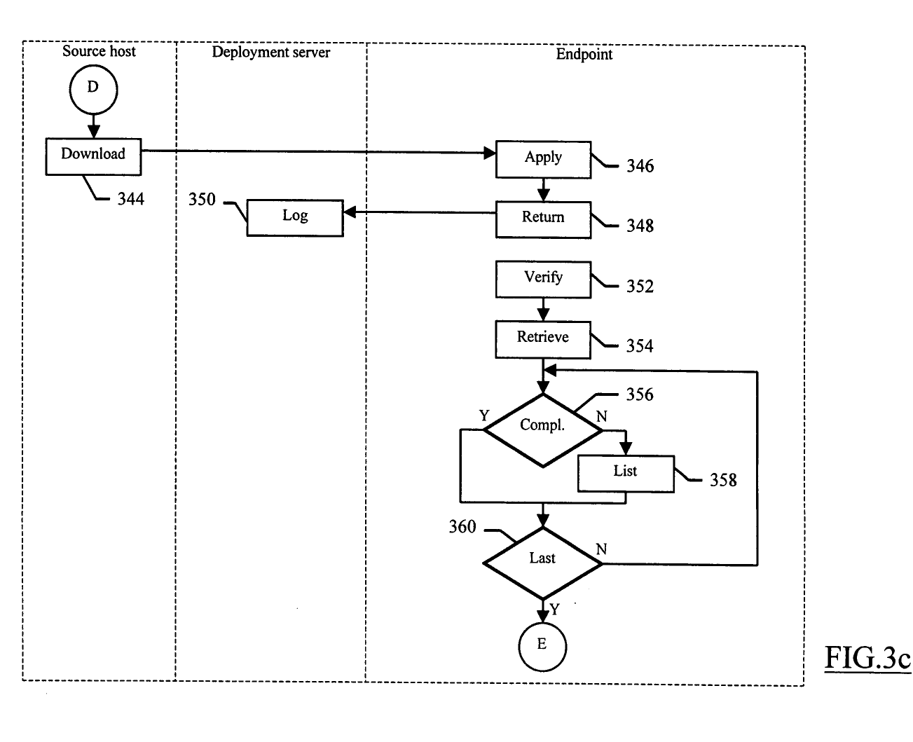

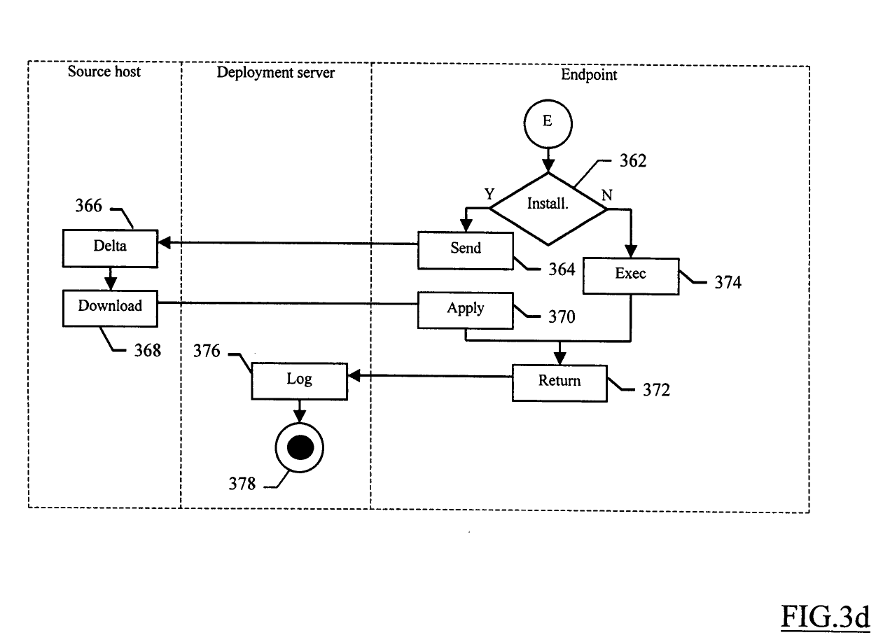

Considering now FIGS. 3a-3d, the logic flow corresponding to the deployment of a software package to a selected endpoint is represented with a method 300. The method begins at the black start circle 302 in the swim-lane of the source host. Passing to block 304, the software package is defined by specifying the installation and configuration actions (with the respective conditions and installable objects). The method then moves to block 306 in the swim-lane of the deployment server, wherein an operator selects a reference model to be deployed. A software distribution request for the selected reference model is then submitted at block 308. As a consequence, the synchronization engine generates a corresponding new plan at block 310. Let us assume now that the plan includes an activity relating to the installation of a software package onto an endpoint (wherein the desired software product is not available yet). In this case, a corresponding request is transmitted to the source host; in response thereto, the source host at block 312 retrieves or builds the requested software package (which embeds both its instruction section and the images of the resources to be installed on the endpoint). At the same time, an identification code is returned to the deployment server enabling the operator to monitor and control the distribution process.

Proceeding to block 314, the software package is transmitted to the endpoint. The process takes place across a hierarchy of gateways before reaching the endpoint; the gateways operate as repeaters (or depots), wherein the software package is loaded and stored. The deployment engine on the endpoint is provided with a label of the software package; the endpoint then opens a communication channel to the nearest gateway so as to download the software package directly using a synchronous multiplexing technique. The instruction section of the package is the first file received by the endpoint; the instruction section is simultaneously read and decoded at block 316, in order to create the hierarchical structure of the software package in the working memory of the endpoint.

The application engine reads and traverses the hierarchical structure so obtained top-down (by calling a desired method on the class at the top of the hierarchy, which method in turn calls the same method on its children). For each action, the application engine checks at block 318 whether the endpoint meets the associated condition. If the action can be executed, the method passes to block 320. The flow of activity now branches according to the category of the action (detected according to the corresponding attribute).

Particularly, for an installation action the method descends into decision block 322. If the installation action involves the update or the removal of a pre-existing resource on the endpoint, a back-up copy of the resource is performed at block 324; the process then continues to block 326 (described in the following). Conversely (i.e., when the action involves the adding of a resource or it is not associated with any installable object), the method descends into block 326 directly.

Referring back to block 320, a configuration action is processed at block 328. In this case, each formal parameter included in the definition of the configuration action is resolved into an actual value. For this purpose, the formal parameter is replaced by the corresponding desired value defined in the mapping list; alternatively, the formal parameter is set to a value that is stored on the endpoint or is input by a user (for example, the identifier of the endpoint or the name of the user). The method then descends into block 326. In this way, the configuration options are defined at run-time. Moreover, this operation is carried out on the endpoint; therefore, the configuration options can be customized according to its physical/logical characteristics.

The flow of activity merges at block 326, wherein the installation action or the (resolved) configuration action is actually executed on the endpoint. Considering now block 330, the action is stored into the deployment log, together with the possible values that have been assigned to any configuration option; the deployment log further stores an indication of the result of the execution of the action. The same point is also reached from block 318 directly when the endpoint does not meet the condition associated with the action (in this case, the deployment log stores an indication that the action has not been executed for that reason). A test is made at block 332 to determine whether the last action of the software package has been processed. If not, the method returns to block 318 for verifying and possibly executing a next action. Conversely, when the last action of the software package has been processed the method descends into block 334. Information about the result of the application of the software package on the endpoint is returned to the configuration server; particularly, the information indicates whether the respective software product has been successfully installed and configured, and the values that have been used for its configuration options. In response thereto, the planner at block 336 updates the entry for the endpoint in the corresponding database accordingly.

Let us assume now that a change is desired in the configuration of the software product, which has been installed on the endpoint as described above. In this case, the configuration map is updated in the corresponding reference model at block 338 (specifying the new desired values of the operative options). A corresponding software distribution request is submitted at block 339. As a consequence, a new plan is generated at block 340 by the synchronization engine. In this case, however, the synchronization engine determines that the software product is already installed on the endpoint (according to the information stored in the endpoint database); therefore, the plan will include an activity only involving the configuration of the software package on the endpoint. A corresponding request is transmitted to the source host; in response thereto, the source host at block 342 builds the requested software package without embedding any installable object (i.e., with the instruction section only).

Proceeding to block 344, the software package is transmitted to the endpoint. The software package is then applied on the endpoint at block 346, repeating the same operations described above (at block 318-332) for the configuration actions only (with the installation actions that are skipped). Particularly, the instruction section of the software package is decoded. Any formal parameter included in each configuration action is resolved into the corresponding desired value, and the configuration action is executed (if the endpoint meets the corresponding condition). The configuration action is then stored into the deployment log (together with the values that have been assigned to any configuration option), by replacing the pre-existing record for the same configuration action. Continuing to block 348, information indicating whether the respective software product has been successfully configured (and the values that have been used for this purpose) is returned to the deployment server. In response thereto, the planner at block 350 updates the entry for the endpoint in the corresponding database accordingly. In this way, the product can be reconfigured on the endpoint without requiring its reinstallation.

The above-described scenario also supports a repair function, which is invoked at block 352 in the swim-lane of the endpoint; for example, the function is executed periodically, following a request received from the deployment server, or upon detection of a change in the (hardware or software) configuration of the endpoint.

In response thereto, the verification module at block 354 retrieves the actions that have been applied on the endpoint from the deployment log. For each action (starting from the first one), a test is made at block 356 to verify whether the endpoint is still compliant with the action. Particularly, for an installation action the verification module checks whether the corresponding software resource is in the condition specified by the action (for example, installed or removed); conversely, for a configuration action the verification module checks whether the corresponding operative parameters have the desired values. If the result of the verification is negative, the action is inserted into a repair list at block 358; the method then continues to block 360. Conversely, if the endpoint is complaint with the action the flow of activity descends into block 360 directly. Considering now block 360, a test is made to determine whether the last action in the deployment log has been processed. If not, the method returns to block 356 for repeating the same operations on a next action.

As soon as all the actions have been verified, the method enters decision block 362. If the repair list contains one or more installation actions, those actions are notified to the source host at block 364. In response thereto, the source host at block 366 builds a delta package for restoring the desired condition of the corresponding resources on the endpoint (including the required images). Continuing to block 368, the delta package is distributed to the endpoint. Returning to the swim-lane of the endpoint, the delta package is applied at block 370 (repeating the operations described above). The process then descends into block 372 (described in the following). Is should be noted that the delta package can be applied without reinstalling the whole software product; indeed, the delta package also includes any configuration action that is required to restore the correct condition of the resources (being the values of the corresponding configuration options persistent).

Referring back to block 362, if the repair list contains configuration actions only, those actions are executed on the endpoint directly at block 374. The flow of activity likewise continues to block 372. In this way, any error in the configuration of the software product can be corrected on the endpoint directly.

Considering now block 372, the result of the application of the actions in the repair list is returned to the configuration server. In response thereto, the information relating to the endpoint in the corresponding database is updated accordingly at block 376. The method then ends at the concentric black/white stop circles 378.

Although the invention has been described above with a certain degree of particularity with reference to preferred embodiment(s) thereof, it should be understood that various changes in the form and details as well as other embodiments are possible.

For example, similar considerations apply if the system has a different topology (for example, with multiple source hosts and deployment servers, or with the source host and the deployment server that are combined into a single entity), or if the computers are coupled in a different way. Alternatively, the computers have another structure, include equivalent units, or are replaced with different data processing entities (such as PDAs, mobile phone, and the like).

Moreover, the programs and the corresponding data can be structured in a different manner, or the programs can be distributed on any other computer readable medium (such as a DVD). In any case, the concepts of the invention are also applicable when the software packages have a different structure, or the actions are defined in another way.

Likewise, the solution of the invention can be implemented with a method including equivalent steps. Particularly, in a different embodiment the software package is built from its instruction section including the actions of the selected category only.

Similar considerations apply if the mapping list is replaced with an equivalent structure, or if other information is stored on each endpoint (to indicate the setting of the configuration options of the software products).

In addition, the proposed method leads itself to be implemented by a computer program that is pre-loaded onto the hard-disk, is sent to the computer through a network (typically the INTERNET), is broadcast, or more generally is provided in any other form directly loadable into the working memories of the computers. However, the method according to the present invention is also suitable to be carried out with a hardware structure (for example, integrated in a chip of semiconductor material), or with a combination of software and hardware.

Moreover, it will be apparent to those skilled in the art that the additional features providing further advantages are not essential for carrying out the invention, and may be omitted or replaced with different features.

For example, the desired values for the configuration options can be hard-coded into the configuration actions.

Moreover, it is possible to resolve the formal parameters only according to the mapping list or to values depending on the endpoint; alternatively, the formal parameters can be resolved when the software package is built (on the source host).

In any case, the solution of the invention is also suitable to be used in different scenarios (for example, in a software application that does not support the repair function).

In addition, the implementation of the proposed method without storing configuration information on the endpoints is not excluded.

Naturally, in order to satisfy local and specific requirements, a person skilled in the art may apply to the solution described above many modifications and alterations all of which, however, are included within the scope of protection of the invention as defined by the following claims

1. A software distribution method including the steps of:
providing a software package defining a plurality of actions for deploying a software product, the actions being partitioned into an installation category for loading the software product and a configuration category for setting configuration options of the software product,
selecting at least one of the categories, and
applying the software package on a target data processing entity to execute the actions of the at least one selected category.

2. The method according to claim 1, wherein at least one action of the configuration category defines at least one formal parameter for the setting of a corresponding configuration option, the method further including the step of:
resolving each formal parameter into a desired value of the corresponding configuration option.

3. The method according to claim 2, wherein the software package further includes a mapping structure associating at least one formal parameter with the corresponding desired value.

4. The method according to claim 2, wherein the step of resolving each formal parameter is performed on the target data processing entity.

5. The method according to claim 1, further including the steps of:
performing a first application of the software package with the selection of the installation category and the configuration category, and
performing a second application of the software package with the selection of the configuration category only.

6. The method according to claim 1, further including the steps of:
verifying a compliance of the target data processing entity with each executed action,
re-executing each action of the installation category in response to a negative result of the verification to restore the loading of the software product, and
re-executing each action of the installation category in response to a negative result of the verification to restore the setting of the configuration options.

7. The method according to claim 6, further including the step of:
storing an indication of the setting of the configuration options on the target data processing entity.

8. A computer program including program code means directly loadable into a working memory of a data processing system for performing the method of claim 1 when the program is run on the system.

9. A program product including a computer readable medium embodying the program of claim 8.

10. A software distribution system including:
means for providing a software package defining a plurality of actions for deploying a software product, the actions being partitioned into an installation category for loading the software product and a configuration category for setting configuration options of the software product,
means for selecting at least one of the categories, and
means for applying the software package on a target data processing entity to execute the actions of the at least one selected category.
